(19) United States
(12) Patent Application Publication
(10) Pub. No.: US 2025/0153252 A1
(43) Pub. Date: May 15, 2025

(54) Holding system for temporarily holding a workpiece, method for adjusting a holding force in a holding arrangement, computer program and device for data processing

(71) Applicant: Murrelektronik GmbH, Oppenweiler (DE)

(72) Inventors: Olaf Prein, Lügde-Rischenau (DE); Marco Bosch, Weilheim A.D. Teck (DE)

(21) Appl. No.: 18/940,513

(22) Filed: Nov. 7, 2024

(30) Foreign Application Priority Data
Nov. 10, 2023 (DE) 2023 131 281.2

(51) Int. Cl. B23B 31/16; B23B 31/10

(52) U.S. Cl. CPC B23B 31/16275; B23B 31/102; B23B 2260/128

(57) ABSTRACT

The invention relates to a holding system (1) for temporarily holding a workpiece, comprising a holding apparatus (10) that has at least one or more existing holding units (11-14) for holding a workpiece with a retaining force of the particular holding unit (11-14), a detection means (20) that is designed to quantify a change in the retaining force of the existing holding units (11-14), and an adjustment means (30) that is designed to adapt the retaining force of a further holding unit (15) based on the quantified change.

The present invention relates to a holding system for temporarily holding a workpiece, to a method for adapting a retaining force for a holding apparatus, and to a computer program and a device for data processing for carrying out such a method.

Holding systems including a holding apparatus are known in principle from the prior art. For example, DE 10 2021 002 418 B3 describes a method for creating gripper sequence programs.

The object of the present invention is to provide an improved holding system for temporarily holding a workpiece, and an improved method for adapting a retaining force for a holding apparatus.

This object is achieved by the subject matter of the independent claims. Further features and details of the invention result from the respective subclaims, the description, and the drawings. Features and details that are described in conjunction with the holding system according to the invention naturally also apply in conjunction with the method according to the invention, the device according to the invention, and the computer program according to the invention, and vice versa in each case, so that with regard to the disclosure, reciprocal reference always is or may be made to the individual aspects of the invention.

According to a first aspect, a holding system for temporarily holding a workpiece is provided.

The holding system includes a holding apparatus that has at least one or more existing holding units for holding a workpiece with a retaining force of the particular holding unit. In addition, the holding system may include a detection means that is designed to quantify a change and/or difference in the retaining force of the existing holding unit(s). Furthermore, the holding system may include an adjustment means that is designed to adapt the retaining force of a further, in particular new, holding unit based on the quantified change/difference. This allows in particular dynamic control of the retaining force, adapted to the existing situation of the holding system. The advantage may thus be achieved that a more homogeneous and uniform retaining force is exerted by all holding units, thus improving the reliability and processing quality during operation of the holding system, as well as maintenance and repair of the holding system. The change may be, for example, a change in the retaining force compared to a reference retaining force, for example the retaining force in an original state, for example an installed state of the existing holding unit(s).

The holding system according to the invention is used in particular to adapt a retaining force of a new holding unit, which in particular is provided for replacement, to the retaining force of one or more existing holding units in order to exert a homogeneous and uniform retaining force on a workpiece during the holding. It is possible for a holding unit to be exchanged, in particular a defective holding unit, to be replaced by the new holding unit.

The holding system, which may also be referred to as a holding device, retaining device, and/or retaining system, advantageously includes, firstly, a holding apparatus having one or more holding units for holding a workpiece with a retaining force. These holding units may also be referred to as existing or present holding units.

The holding units in particular have retaining means that are designed to fix, grip, and/or hold a workpiece, and may also be referred to as grippers or gripping devices.

The holding units may be designed to hold a workpiece, temporarily or for a predefined time period, with a particular retaining force which may also be referred to as a holding force.

This retention may be used in particular to hold the workpiece for one or more machining or processing steps in a production line, so that a machining device can carry out these steps on the workpiece.

The holding system may also include a detection means that is designed to ascertain and in particular quantify a change and/or difference in the retaining force of the existing retaining means.

The change may in particular be a worsening and/or a reduction of the retaining force, which is ascertained, for example, compared to an initial preset and/or predetermined retaining force, which may also be referred to as a reference retaining force. The change in the retaining force may occur in particular due to aging and/or wear.

The quantification of the change may be ascertained in particular in an absolute or a relative manner, for example with regard to the reference retaining force that is provided to the detection means or retrieved therefrom.

The holding system may also include an adjustment means that is designed to adapt the retaining force of a further holding unit, based on the quantified change.

The further holding unit may in particular be a holding unit that is different from the existing holding units, but which in particular may be from the same manufacturer or of the same type or model as the existing holding units.

In particular, the further holding unit may be a holding unit that has experienced no change and/or that has not experienced the same change as the existing holding units.

For example, the further holding unit may be a holding unit that is new and/or unused, or that has at least been used to a lesser extent than the existing holding units. In particular, the further holding unit may have no or only slight change, worsening, and/or reduction of the retaining force compared to a reference retaining force.

It is also conceivable for the further holding unit to differ from the existing holding units via a type and/or a design and/or a technical specification. In this case, the adaptation may also be used to minimize the disparity of the retaining force due to this difference.

By use of the holding system according to the invention, it is possible in particular to adapt a retaining force of a new holding unit, provided for replacement, to the retaining force of one or more existing holding units in order to exert a homogeneous and uniform retaining force on a workpiece during the holding.

It is possible for the holding system to also include a recognition means that is designed to recognize provision of the further holding unit, preferably a replacement of a holding unit to be exchanged with the further holding unit, wherein the adjustment means may be designed to set the retaining force of the further holding unit in response to the recognized provision. In particular, the recognition means may be designed to recognize a replacement of an existing holding unit to be exchanged with the further holding unit, for example because the existing holding unit has experienced a change, in particular a worsening, of the retaining force beyond a predetermined threshold value, in particular to zero, because the existing holding unit to be exchanged has failed and/or sustained a defect or damage, and/or because the existing holding unit to be exchanged has reached or attained a predetermined maximum operational age, a predetermined maximum number of performed holding operations, and/or a predetermined maximum sum of an applied retaining force. Alternatively or additionally, the further holding unit may include an information element which indicates the age and/or the state, in particular that it is new and/or unused, and which may be read out by the recognition means. The adjustment means may be designed to set the retaining force of the further holding unit in response to the recognized provision of the further holding unit. In particular, the provision of the further holding unit triggers setting of the retaining force of the further holding unit by the adjustment means. This allows the retaining force of the further holding unit to be set in particular in an automated manner and without human involvement.

It is also possible for the detection means to be designed to quantify the change by ascertaining an operational age of the existing holding units in order to determine an age-related reduction in the retaining force based on the ascertained operational age. An operational age of the existing holding units may thus be ascertained. This may be achieved, for example, by a date function and/or a clock function that are/is triggered in particular upon provision of the holding unit as a new or further holding unit. Alternatively or additionally, the operational age may be ascertained via an operating hours counter. In particular, an independent value may be ascertained for each of the existing holding units. This is advantageous in particular when the existing holding units have different operational ages. It is thus possible to quantify the change in a particularly cost-effective manner, since direct force sensors are not needed.

It is also possible for the detection means to be designed to quantify the change by ascertaining a number of performed holding operations of the existing holding units in order to determine an operation-related reduction in the retaining force based on the ascertained holding operations. In particular, each holding operation of each existing holding unit may be counted or summed in order to ascertain the number of performed holding operations. An independent value may be ascertained in particular for each of the existing holding units. This is advantageous in particular when the existing holding units have different numbers of performed holding operations. This also enables the change to be quantified in a particularly cost-effective manner, since direct force sensors are not needed.

It is also possible for the detection means to be designed to quantify the change by ascertaining a sum of an applied retaining force of the existing holding units over a past operation of the existing holding unit, in order to determine a load-related reduction in the retaining force based on the ascertained sum. The sum of the applied retaining force may be ascertained using a force detection device, as described in greater detail in conjunction with the embodiment that follows, or also by multiplying the initial retaining force by the number of performed holding operations. For example, as the basis a correction factor may be used which takes into account or at least estimates a change in the retaining force, and/or the sum of the applied calculated retaining force without a correction factor may be used which, however, is proportional to the actually changed retaining force. In particular, an independent value may be ascertained for each of the existing holding units. This is advantageous in particular when the existing holding units have applied various retaining force sums or have different numbers of performed holding operations. By use of this embodiment, it is possible for the change to be quantified in a particular exact manner, not just estimated.

The detection means may carry out a detection of the retaining force, in particular the force applied to a workpiece, preferably by grippers driven by electric motors, at the holding units, for example by metrologically detecting the force that is exerted. Pressure sensors or load cells may be used for this purpose. The detection means is designed, for example, as an electronic device such as a control device, force measuring device, or sensor. In addition, a calculation that is carried out automatedly and in particular electronically may be provided in order to quantify the change in the retaining force based on the metrologically determined result. The adjustment means may have a communication link with the detection means and/or may be designed to adapt the retaining force of a further holding unit based on the quantified change. For this purpose, for example a controller in an automation device may be parameterized and/or configured and/or reprogrammed. It is thus possible, for example, to influence how the controller activates an electric motor that moves the holding unit for gripping the workpiece. The adjustment means is designed, at least in part, for example as a computer program that ascertains the quantified change in the retaining force of the holding unit(s), and based on this information adapts the retaining force of the further holding unit. The computer program may be integrated into an automation device, and may communicate with the detection means via an interface. Due to adapting the retaining force, for example the gripping force of the workpiece may be optimized to ensure reliable and effective processing.

It is also possible for the detection means to be designed to ascertain a retaining force of the existing holding units and to quantify the change based on the ascertained retaining force, wherein the retaining force may be detected by a force detection device and provided for the detection means. It is thus possible for a retaining force to not just be estimated or determined based on other information, but actually measured. This takes place by use of one or more force detection devices. In particular, an independent force detection device may be provided for each of the existing holding units. In particular, according to this embodiment at least, in particular only, the retaining force of the existing holding unit that is to be exchanged is ascertained, in particular because it has reached or attained a predetermined maximum operational age, a predetermined maximum number of performed holding operations, and/or a predetermined maximum sum of an applied retaining force. Here as well, it is thus possible for the change to be quantified in a particular exact manner, not just estimated.

It is likewise possible for the detection means to be designed to ascertain the particular retaining force of the multiple holding units and to determine an average value therefrom, wherein the adjustment means may be designed to set the retaining force of the further holding unit to the average value. It is thus possible to determine and form an average value, in particular over all retaining forces that are detected by use of the force detection devices, and to set the retaining force of the further holding unit to this average value. This makes it possible to ascertain a particularly robust quantification of the change.

It is also possible for the detection means to be designed to ascertain the change in the retaining force of the existing holding units and of the further holding unit, wherein the adjustment means may be designed to set the retaining force of the further holding unit, based on the ascertained retaining forces. It is thus possible in particular to provide not just the existing holding units, but also the further holding unit, with force detection devices. In particular in a test or trial run, the retaining force of all holding units, in particular also of the further holding unit, may be detected, and the retaining force of the further holding unit may subsequently be set to that of the existing holding units, in particular an average value. An even more accurate quantification or setting is thus made possible. In particular, it is thus possible not just to assume or estimate the retaining force of the further holding unit, but to precisely quantify it and thus set it in a particularly accurate manner.

It is also possible to provide a clamping frame in order to fix the workpiece for machining, wherein the multiple holding units, in particular in the form of grippers, may be situated at the clamping frame in order to hold the workpiece at different locations with a uniform retaining force, wherein the holding units may each include an electric motor for providing the retaining force in order to control a gripping movement of a gripping means for holding the workpiece, and a gear for transferring the provided retaining force from the electric motor to the gripping means in order to carry out the gripping movement at the workpiece. The electric motor may be connected to an automation device for power and/or signal transmission, in particular for transmitting data signals and/or control signals, wherein the detection means and the adjustment means and preferably the recognition means may optionally be part of the automation device and in particular of a computer program of the automation device. The connection between the automation device and the electric motor may be provided via appropriate cables for data and power transmission.

In addition, for example at least 5 or at least 10 holding units, also referred to as grippers, may be situated at the clamping frame and fastened thereto via screws, bolts, or other fastening elements. The exact number and placement of the holding units depend in particular on the size and characteristics of the workpieces to be fixed. A movement of the holding units may be achieved, for example, by driving them by a motor, in particular an electric motor, which is connected to the holding units via a mechanical connection. Alternatively, the holding units may also be operated pneumatically or hydraulically via impingement by an appropriate pressure means. A further option is the use of electromagnetic fields that move the holding units by acting on magnetic materials in the holding units. The clamping frame may be made of aluminum or steel. In particular, a manual clamping device that is designed for manual fixing of the workpiece to the clamping frame may also be provided.

It is also possible for the adjustment means to be designed to reduce the retaining force of the further holding unit compared to the retaining force of the particular existing holding unit, preferably by adapting a power and/or signal transmission from an automation device to the further holding unit, in order to uniformly distribute the retaining forces at the workpiece. Particularly rapid and simple adaptation of the retaining force is thus made possible.

According to a further aspect, a method for adapting a retaining force for a holding apparatus is provided, in which at least one further holding unit is provided for at least one or more existing holding units in order to hold a workpiece with a uniform retaining force of the particular holding unit.

The method comprises the steps of ascertaining a change indication in order to quantify a change in the retaining force, in particular of the existing holding units, and initiating an adaptation of the retaining force of the further holding unit, based on the change indication, in order to compensate for the quantified change.

The method may be carried out in particular partially or completely, using a holding system described above, or the method is suitable for being used in the holding system and partially or completely implementing its features.

It is possible for the change indication to be specific for a change due to wear of the particular existing holding unit, in particular wear of a gear of the holding unit. A change is thus quantifiable in a particularly exact manner.

It is also possible for the adaptation to be initiated by adapting a signal transmission from an automation device to an electric motor of the further holding device, preferably by adapting control commands and/or a control signal, in order to make a reduction in the retaining force, preferably the tension force, for the further holding device compared to the retaining force, preferably the tension force, of the particular existing holding device. A particularly integrated and user-friendly adaptation is thus made possible.

The subject matter of the invention further relates to a device for data processing, including means for carrying out the steps of the method according to the invention. The device according to the invention thus yields the same advantages as described in detail above with regard to a method according to the invention.

The subject matter of the invention further relates to a computer program, in particular a computer program product, including commands which, when the computer program is executed by a computer, prompt the computer to carry out the method according to the invention. The computer program according to the invention thus yields the same advantages as described in detail above with regard to a method according to the invention.

A data processing device, for example the device according to the invention, which executes the computer program may be provided as the computer. The computer may include at least one processor for executing the computer program. In addition, a nonvolatile data memory may be provided in which the computer program is stored, and from which the computer program may be read out by the processor for the execution.

It is also conceivable for the computer to include at least one integrated circuit, such as a microprocessor or an application-specific integrated circuit (ASIC) or an application-specific standard product (ASSP) or a digital signal processor (DSP) or a field programmable gate array (FPGA) or the like. The computer may also include at least one interface for data exchange, for example an Ethernet interface or an interface for Local Area Network (LAN) or Wireless Local Area Network (WLAN) or system on chip (SoC) or some other wireless interface such as Bluetooth or near field communication (NFC). In addition, the computer may be designed as one or more control devices, i.e., also as a system made up of control devices. The computer may also be provided, for example, in a cloud and/or as a server in order to provide the data processing for a local application via the interface. It is also possible for the computer to be designed as a mobile device, such as a smart phone.

The subject matter of the invention may further relate to a computer-readable memory medium which includes the computer program according to the invention. The memory medium is designed, for example, as a data memory such as a hard disk and/or a nonvolatile memory and/or a memory card. The memory medium may, for example, be integrated into the computer.

Furthermore, the method according to the invention may also be designed as a computer-implemented method.

The invention further encompasses the combinations of the features of the described embodiments. The invention thus also encompasses implementations, each of which has a combination of the features of several of the described embodiments, provided that the embodiments have not been described as mutually exclusive.

Exemplary embodiments of the invention are described below. In the figures:

FIG. 1 shows a schematic side view of one embodiment of a holding system for temporarily holding a workpiece;

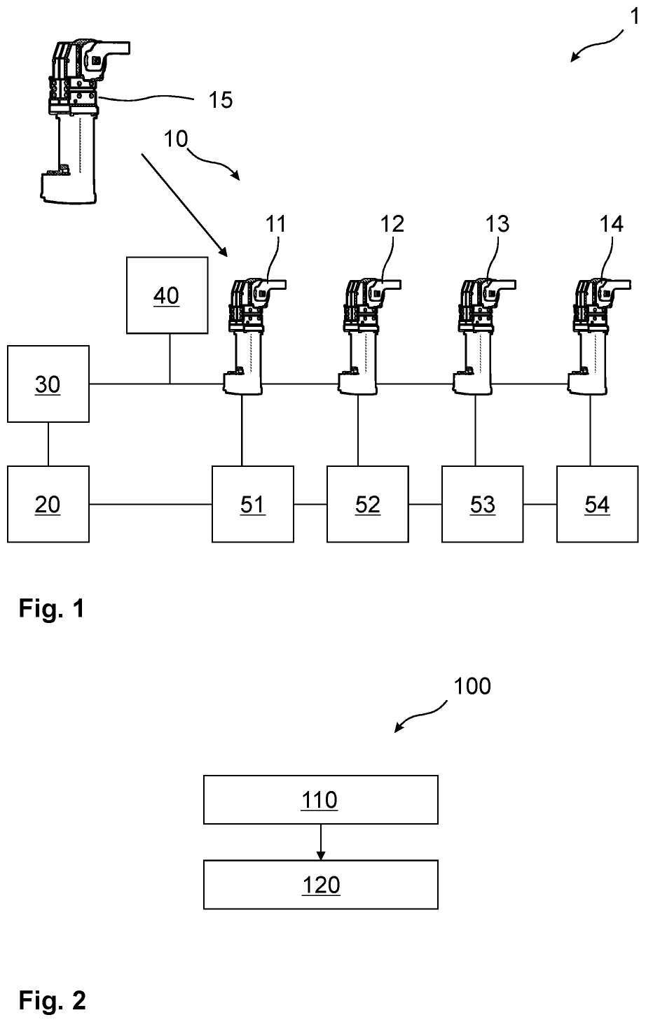

FIG. 2 shows a schematic flow chart of one embodiment of a method for adapting a retaining force for a holding apparatus;

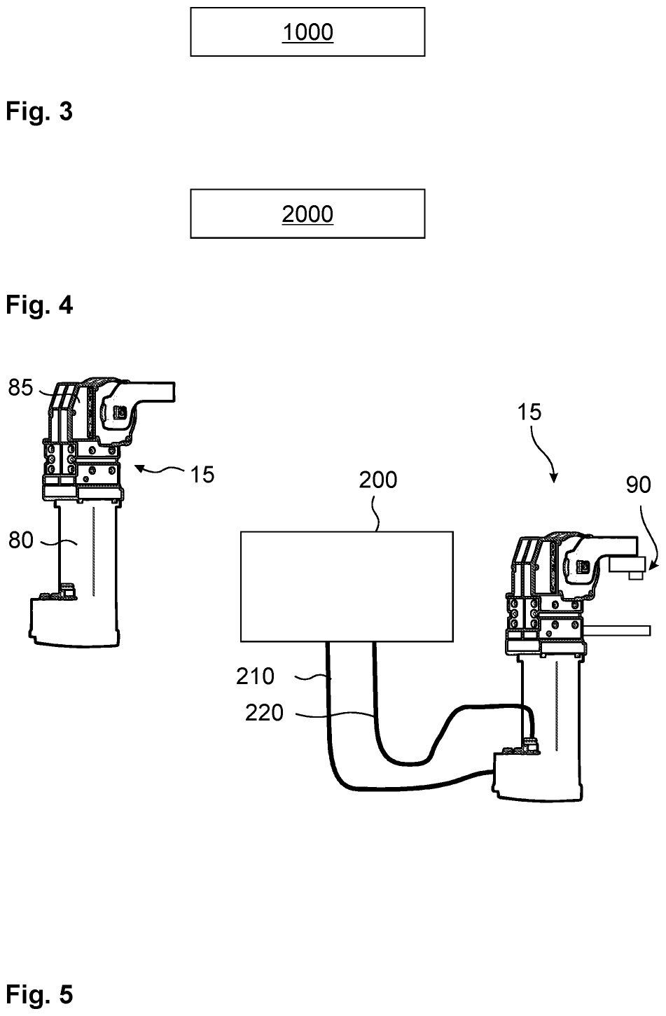

FIG. 3 shows a device for data processing;

FIG. 4 shows a computer program;

FIG. 5 shows further particulars of a holding system according to one exemplary embodiment of the invention;

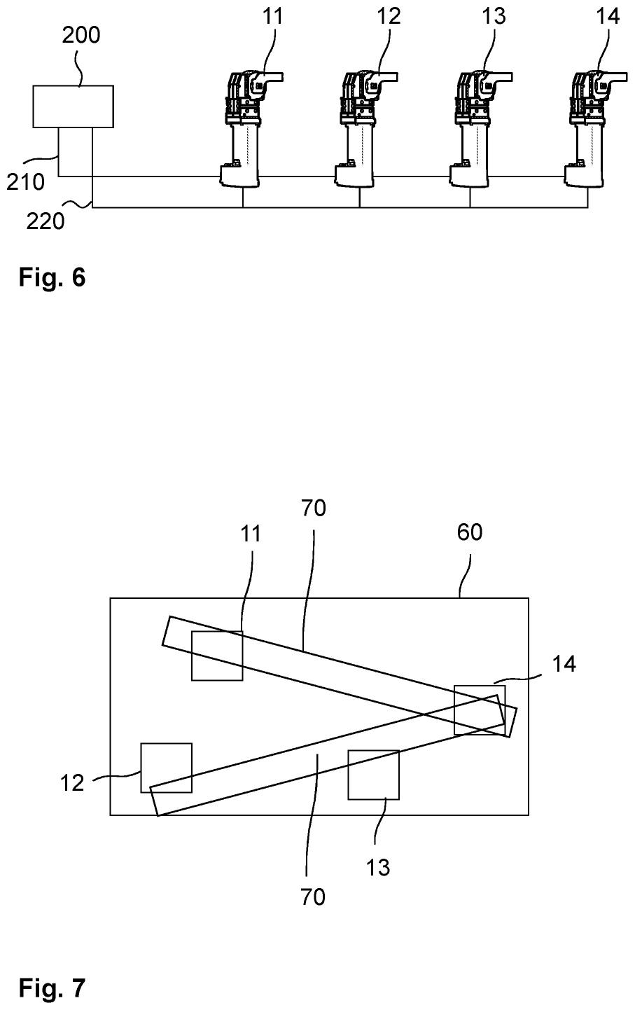

FIG. 6 shows further particulars of a holding system according to one exemplary embodiment of the invention; and

FIG. 7 shows further parts of a holding system according to one exemplary embodiment of the invention.

FIG. 1 shows a schematic side view of one embodiment of a holding system 1 for temporarily holding a workpiece, not depicted in greater detail here.

The holding system 1 includes a holding apparatus 10 that has at least one or more existing holding units 11 through 14, of which four existing holding units 11 through 14 are depicted here by way of example. The holding units 11 through 14 are designed to hold a workpiece with a retaining force of the respective holding unit 11 through 14.

The holding system 1 may also include a detection means 20 that is designed to quantify a change in the retaining force of the existing holding units 11 through 14. In the present case, it is assumed by way of example that the existing holding unit 11 is defective and is to be replaced by a further, new holding unit 15. For this purpose, the holding system 1 may include an adjustment means 30 that is designed to adapt the retaining force of a further holding unit 15, based on the quantified change.

The holding system 1 may also include a recognition means 40 that is designed to recognize provision of the further holding unit 15, preferably replacement of a holding unit 11 to be exchanged with the further holding unit 15, the adjustment means 40 being designed to set the retaining force of the further holding unit 15 in response to the recognized provision.

The detection means 20 may be designed to quantify the change by ascertaining an operational age of the existing holding units 11 through 14 in order to determine an age-related reduction in the retaining force based on the ascertained operational age.

Alternatively or additionally, the detection means 20 may be designed to quantify the change by ascertaining a number of performed holding operations of the existing holding units 11 through 14 in order to determine an age-related reduction in the retaining force based on the ascertained holding operations.

Also alternatively or additionally, the detection means 20 may be designed to quantify the change by ascertaining a sum of an applied retaining force of the existing holding units 11 through 14 over a past operation of the existing holding units 11 through 14, in order to determine a load-related reduction in the retaining force based on the ascertained sum.

Also alternatively or additionally, the detection means 20 may be designed to ascertain a retaining force of the existing holding units 11 through 14 and to quantify the change based on the ascertained retaining force, wherein the retaining force is detected by at least one force detection device and is provided for the detection means. As shown in the present case, for each of the existing holding units 11 through 14, respective force detection devices 51 through 54 are provided which are able to detect the retaining force of each of the existing holding units.

Also alternatively or additionally, the detection means 20 may be designed to quantify the change by evaluating a manual input by a user. For this purpose, the detection means 20 may provide an input interface for the user.

The detection means 20 may also be designed to ascertain the respective retaining force of the multiple holding units 11 through 14 and to determine an average value therefrom, wherein the adjustment means 30 is designed to set the retaining force of the further holding unit 15 to the average value.

The detection means 20 may also be designed to ascertain the change in the retaining force of the existing holding units 11 through 14 and of the further holding unit 15, wherein the adjustment means 30 is designed to set the retaining force of the further holding unit 15 based on the ascertained retaining forces.

A clamping frame 60, depicted in FIG. 7, may also be provided for the holding system 1 in order to fix the workpiece (denoted here by reference numeral 70 by way of example) for machining, the multiple holding units 11 through 14 being situated at the clamping frame 60 in order to hold the workpiece at different locations with a preferably uniform retaining force. The holding units 11 through 14 and optionally also 15 may each include an electric motor 80, only schematically shown in FIG. 5, the electric motor 80 being designed to provide the retaining force in order to control a gripping movement of a gripping means 90 for holding the workpiece. The holding units 11 through 14 and optionally also 15 may also include a gear 85, likewise only schematically shown, for transferring the provided retaining force from the electric motor 80 to the gripping means 90 in order to carry out the gripping movement at the workpiece. For power and/or signal transmission, the electric motor 80 is connected to an automation device 200, in particular via appropriate data cables 210 and/or power cables 220, for supplying electrical power (see FIG. 6), wherein the detection means 20 and the adjustment means 30 and preferably the recognition means 40 may each be designed as part of the automation device 200 or separately from same, and in particular are parts of a computer program.

The adjustment means 30 may be designed to reduce the retaining force of the further holding unit 15 compared to the retaining force of the respective existing holding units 11 through 14, preferably by adapting a power and/or signal transmission from an automation device 200 to the further holding unit 15 in order to uniformly distribute the retaining forces at the workpiece.

FIG. 2 shows a schematic flow chart of one embodiment of a method 100 for adapting a retaining force for a holding apparatus. The shown method 100 is used to adapt a retaining force for a holding apparatus, in particular a holding apparatus 10 shown in conjunction with FIG. 1 or the retaining system 1 shown therein, in which at least one further holding unit is provided for at least one or more existing holding units in order to hold a workpiece with a uniform retaining force of the particular holding unit.

In a first step 110 of the method 100, a change indication is ascertained in order to quantify a change in the retaining force.

In a further step 120 of the method 100, an adaptation of the retaining force of the further holding unit is initiated, based on the change indication, in order to compensate for the quantified change.

The change indication for a change may be specific for wear of the particular existing holding unit, in particular wear of a gear of the holding unit.

The adaptation may be initiated in particular by adapting a signal transmission from an automation device to an electric motor of the further holding device, preferably by adapting control commands and/or a control signal, in order to make a reduction in the retaining force, preferably the tension force, for the further holding device compared to or compensated for the retaining force, preferably the tension force, of the particular existing holding device.

FIG. 3 shows a device 1000 for data processing, including means for carrying out a method for adapting a retaining force for a holding apparatus as described in conjunction with FIG. 2.

FIG. 4 shows a computer program 2000 which in particular may be designed as a computer program product, and which includes commands which, when the computer program is executed by a computer, prompt the computer to carry out a [method] for adapting a retaining force for a holding apparatus as described in conjunction with FIG. 2.

### LIST OF REFERENCE NUMERALS

1 holding system
10 holding apparatus
11-14 existing holding unit
15 further holding unit
20 detection means
30 adjustment means
40 recognition means
51-54 force detection device
60 clamping frame
70 workpiece
80 electric motor
85 gear
90 gripping means
100 method
110 method step
120 method step
200 automation device
210 data cable
220 power cable
1000 device
2000 computer program

1. A holding system for temporarily holding a workpiece, comprising:
a holding apparatus that has at least one or more existing holding units for holding a workpiece with a retaining force of the particular holding unit;
a detection means that is designed to quantify a change in the retaining force of the existing holding units; and
an adjustment means that is designed to adapt the retaining force of a further holding unit based on the quantified change.

2. The holding system according to claim 1,
characterized in that
the holding system further comprises:
a recognition means that is designed to recognize provision of the further holding unit, preferably a replacement of a holding unit to be exchanged with the further holding unit,
wherein the adjustment means is designed to set the retaining force of the further holding unit in response to the recognized provision.

3. The holding system according to claim 1,
characterized in that
the detection means is designed to quantify the change by ascertaining an operational age of the existing holding units in order to determine an age-related reduction in the retaining force based on the ascertained operational age.

4. The holding system according to claim 1,
characterized in that
the detection means is designed to quantify the change by ascertaining a number of performed holding operations of the existing holding units (in order to determine an operation-related reduction in the retaining force based on the ascertained holding operations.

5. The holding system according to claim 1,
characterized in that
the detection means is designed to quantify the change by ascertaining a sum of an applied retaining force of the existing holding units over a past operation of the existing holding unit, in order to determine a load-related reduction in the retaining force based on the ascertained sum.

6. The holding system according to claim 1,
characterized in that
the detection means is designed to ascertain a retaining force of the existing holding units and to quantify the change based on the ascertained retaining force, wherein the retaining force is detected by a force detection device and provided for the detection means.

7. The holding system according to claim 1,
characterized in that
the detection means is designed to ascertain the particular retaining force of the multiple holding units and to determine an average value therefrom,
wherein the adjustment means is designed to set the retaining force of the further holding unit to the average value.

8. The holding system according to claim 1,
characterized in that
the detection means is designed to ascertain the change in the retaining force of the existing holding units and of the further holding unit, wherein the adjustment means is designed to set the retaining force of the further holding unit based on the ascertained retaining forces.

9. The holding system according to claim 1,
characterized in that
a clamping frame is provided in order to fix the workpiece for machining, wherein the multiple holding units are situated at the clamping frame in order to hold the workpiece at different locations with a preferably uniform retaining force, wherein the holding units each include:
an electric motor for providing the retaining force in order to control a gripping movement of a gripping means for holding the workpiece,
a gear for transferring the provided retaining force from the electric motor to the gripping means in order to carry out the gripping movement at the workpiece,
wherein the electric motor is connected to an automation device for power and/or signal transmission, wherein the detection means and the adjustment means and preferably the recognition means are part of the automation device and in particular of a computer program of the automation device.

10. The holding system according to claim 1,
characterized in that
the adjustment means is designed to reduce the retaining force of the further holding unit compared to the retaining force of the particular existing holding units, preferably by adapting a power and/or signal transmission from an automation device to the further holding unit, in order to uniformly distribute the retaining forces at the workpiece.

11. A method for adapting a retaining force for a holding apparatus, in which at least one further holding unit is provided for at least one or more existing holding units in order to hold a workpiece with a uniform retaining force of the particular holding unit, comprising:
ascertaining a change indication in order to quantify a change in the retaining force,
initiating an adaptation of the retaining force of the further holding unit, based on the change indication, in order to compensate for the quantified change.

12. The method according to claim 11,
characterized in that
the change indication is specific for a change due to wear of the particular existing holding unit, in particular wear of a gear of the holding unit.

13. The method according to claim 11,
characterized in that
the adaptation is initiated by adapting a signal transmission from an automation device to an electric motor of the further holding device, preferably by adapting control commands and/or a control signal, in order to make a reduction in the retaining force, preferably the tension force, for the further holding device compared to and/or compensated for the retaining force, preferably the tension force, of the particular existing holding device.

14. A device for data processing comprising:
a processor; and
a memory communicatively coupled to the processor and storing a computer program comprising commands, that when executed by the processor, cause the processor to:
ascertain a change indication in order to quantify a change in the retaining force; and
initiate an adaptation of the retaining force of the further holding unit, based on the change indication, in order to compensate for the quantified change.

15. A tangible, non-transitory computer-readable medium storing a computer program comprising commands, which, when the computer program is executed by a computer, prompt the computer to:
ascertain a change indication in order to quantify a change in the retaining force; and
initiate an adaptation of the retaining force of the further holding unit, based on the change indication, in order to compensate for the quantified change.
